(19) United States
(12) Patent Application Publication
(10) Pub. No.: US 2002/0137521 A1
(43) Pub. Date: Sep. 26, 2002

(54) Scheduling method for high-rate data service in a mobile communication system

(75) Inventors: Min-Goo Kim, Suwon-shi (KR); Dae-Gyun Kim, Songnam-shi (KR); Chang-Hoi Koo, Songnam-shi (KR); Dong-Seek Park, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO. LTD., KYUNGKI-DO (KR)

(21) Appl. No.: 10/004,557

(22) Filed: Dec. 3, 2001

(30) Foreign Application Priority Data
Dec. 1, 2000 (KR) 2000-75013

(51) Int. Cl. H04Q 7/20

(52) U.S. Cl. 455/453; 455/452

(57) ABSTRACT

Disclosed is a method for selecting one of a plurality of mobile stations by a base station including a plurality of transmitters. The method comprises analyzing retransmission buffers and initial transmission buffers in the transmitters associated with the mobile stations having transmitting at least two blocks of the C/I information, when the two blocks of the C/I information are equal to each other, and selecting a mobile station associated with a retransmission buffer in which retransmission data is stored; selecting a mobile station associated with a transmitter transmitting data in real time among the transmitters associated with at least two retransmission buffers, when the retransmission data is stored in at least the two retransmission buffers among the retransmission buffers; and selecting one mobile station associated with a retransmission buffer having a longest data length among the retransmission buffers in the two transmitters, when there exist at least two transmitters transmitting data in real time.

### PRIORITY

This application claims priority to an application entitled “Scheduling Method for High-Rate Data Service in a Mobile Communication System” filed in the Korean Industrial Property Office on Dec. 1, 2000 and assigned Ser. No. 2000-75013, the contents of which are hereby incorporated by reference.

### BACKGROUND OF THE INVENTION

1. Field of the Invention

The present invention relates generally to a data transmission apparatus and method based on a protocol structure in a CDMA (Code Division Multiple Access) mobile communication system, and in particular, to a data transmission apparatus and method capable of guaranteeing a multimedia service and a high data rate in a CDMA mobile communication system.

2. Description of the Related Art

In general, a mobile communication system provides both a voice service (or circuit service) and a data service (or packet service). Such a mobile communication system includes an IS-2000 system, an HDR (High Data Rate) system proposed by a 3GPP2 (3^{rd} Generation Partnership Project 2) 1XEV (EVolution) technique, and a 1XTREME system. In those systems, data information transmitted over the same channel has the same QoS (Quality of Service) level. Therefore, it is not possible to provide different QoS levels for inter-media or intra-media service data. That is, the systems are constructed such that it cannot provide the different QoS levels for the respective services of the multimedia service. In addition, the systems cannot optimize their throughputs during a packet data service.

Accordingly, there is a demand for a new data transmission system capable of providing different data rates for the respective service data. In order to provide the different data rates for the data of the respective services, scheduling should be performed accordingly. However, the conventional system cannot properly schedule the service data.

### SUMMARY OF THE INVENTION

It is, therefore, an object of the present invention to provide a method for scheduling data transmitted in a system capable of guaranteeing different QoS levels for respective service data.

It is another object of the present invention to provide a scheduling apparatus and method suitable for a mobile communication system supporting an MQC (Multiple Quality Channel) structure and a TU (Transfer Unit) transmission unit.

It is further another object of the present invention to provide a C/I (Carrier-to-Interference ratio)-based scheduling apparatus and method in a system providing a multimedia service.

It is yet another object of the present invention to provide an apparatus and method for guaranteeing high-rate data transmission and a high throughput during the data transmission through effective scheduling in a protocol structure capable of providing both a data service and a multimedia service.

To achieve the above and other objects, there is provided a method for selecting one of a plurality of mobile stations by a base station including a plurality of transmitters. Each of the transmitters includes a retransmission buffer for storing retransmission data and an initial transmission buffer for storing initial data. The transmitters are capable of providing a data service to associated mobile stations in a region of the base station. The base station provides a data service to the selected one of the mobile stations based on C/I information from the mobile stations. The method comprises the steps of analyzing retransmission buffers and initial transmission buffers in the transmitters associated with the mobile stations having transmitting at least two blocks of the C/I information, when the two blocks of the C/I information are equal to each other, and selecting a mobile station associated with a retransmission buffer in which retransmission data is stored, when the retransmission data is stored in said retransmission buffer among the retransmission buffers; selecting a mobile station associated with a transmitter transmitting data in real time among the transmitters associated with at least two retransmission buffers, when the retransmission data is stored in at least the two retransmission buffers among the retransmission buffers; and selecting one mobile station associated with a retransmission buffer having a longest data length among the retransmission buffers in the two transmitters, when there exist at least two transmitters transmitting data in real time.

Further, the base station retransmits the transmitted data upon failure to receive a response signal from the mobile station within a predetermined time after transmitting the data stored in the transmitter associated with the selected mobile station.

Further, the base station retransmits only previously failed data when a response signal received from the mobile station within a predetermined time after transmitting the data stored in the transmitter associated with the selected mobile station indicates that an error has occurred in part of the transmitted data.

Preferably, the base station selects one of the transmitters excluding a transmitter currently transmitting data to the current mobile station.

Preferably, the base station selects one of the transmitters excluding transmitters whose response waiting time has not expired after transmitting data.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a protocol structure to which a scheduling technique according to an embodiment of the present invention is applied;

FIG. 2 illustrates interfacing between independent function blocks in a physical layer of the protocol structure according to an embodiment of the present invention;

FIG. 3 illustrates a system model for C/I scheduling according to an embodiment of the present invention;

FIG. 4 illustrates a queuing model of the system for the C/I scheduling according to an embodiment of the present invention;

FIG. 5 illustrates a timing diagram for explaining a transmission method based on C/I scheduling during retransmission in a TU unit according to an embodiment of the present invention; and

FIGS. 6A and 6B illustrate a C/I-based scheduling procedure by the base station according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

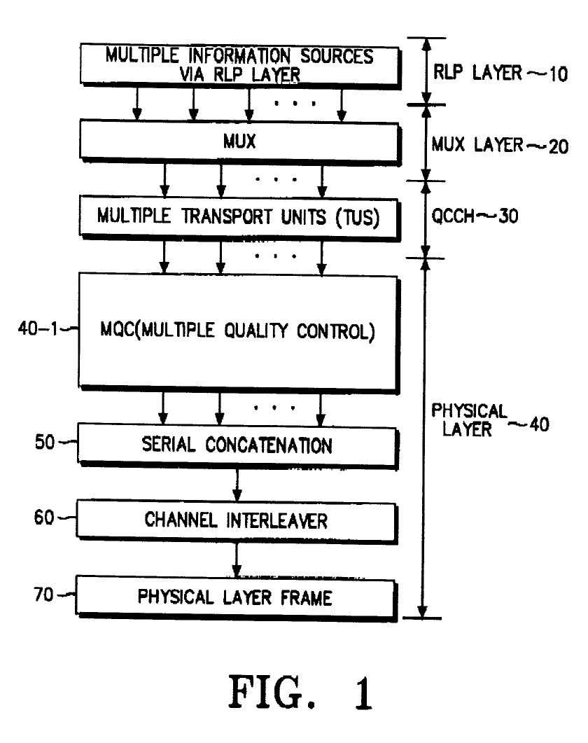

FIG. 1 illustrates a protocol structure to which a scheduling technique according to the present invention is applied. More specifically, FIG. 1 illustrates function blocks of such upper layers as an RLP (Radio Link Protocol Layer) layer 10, an MUX (Multiplexing) layer 20, a QCCH (Quality Control Channel) 30, and a physical layer 40. That is, FIG. 1 illustrates a protocol structure for providing the different QoS levels using the quality control channel, wherein the protocol structure is designed to transmit only user plane information, i.e., pure user information, excluding control information. The system with the protocol structure of FIG. 1 transmits data to only one mobile station (MS) at a certain instant over a forward link at its maximum power. Also shown are serial concatenation part 50, channel interleaver 60, and physical layer frame 70. Reference will now be made to a scheduling technique for the system.

The RLP layer 10 processes a logical channel that can be determined depending on a class of an application service stream. The RLP layer 10 may include a plurality of logical channels according to the class of the application service stream. The logical channels can be provided with either a plurality of independent RLP instances or a single RLP instance. When the logical channels are provided with the plurality of independent RLP instances, the number of the generated independent RLP instances is equal to the number of the classified logical channels. Here, each of the RLP instances provides sequence number management and segmentation functions for the data transmitted over its associated logical channel. However, when the logical channels are managed by a single RLP instance, there is a need for integrated management on the logical channels, rather than independent management on the logical channels. Therefore, when the logical channels are managed by the single RLP instance, the system can perform more functions.

The MUX layer 20 performs a mapping function between the logical channels and the quality control channel 30. The logical channels provided to the MUX layer 20 are mapped to the quality control channel 30 through the following functions.

(1) Multiplexing Functionality

When data transmitted over the logical channel is less in length than a transport unit (TU) transmitted over the quality control channel 30, the data is assembled with data transmitted over another logical channel in order to construct a data unit having a fixed length.

(2) Switching Functionality

When data transmitted over the logical channel is equal in length to the TU transmitted over the quality control channel 30, the data can be mapped to a specific quality control channel 30 without assembling the data with data transmitted over another logical channel. In addition, the switching functionality maps data generated from the logical channels having the same or similar QoS levels to the quality control channel 30 providing a specific QoS level, or provides a function of properly separating data transmitted from the logical channels to constantly activate the quality control channel 30.

(3) QoS Control Functionality

The data on the logical channel can be transmitted over the quality control channel 30 according to its transmission priority. Here, the transmission priority can be determined depending on the characteristic of the logical channel. In addition, the QoS control functionality can be used when the control information is transmitted along with the user information, or when signaling information for transmitting system information is transmitted along with the other data information.

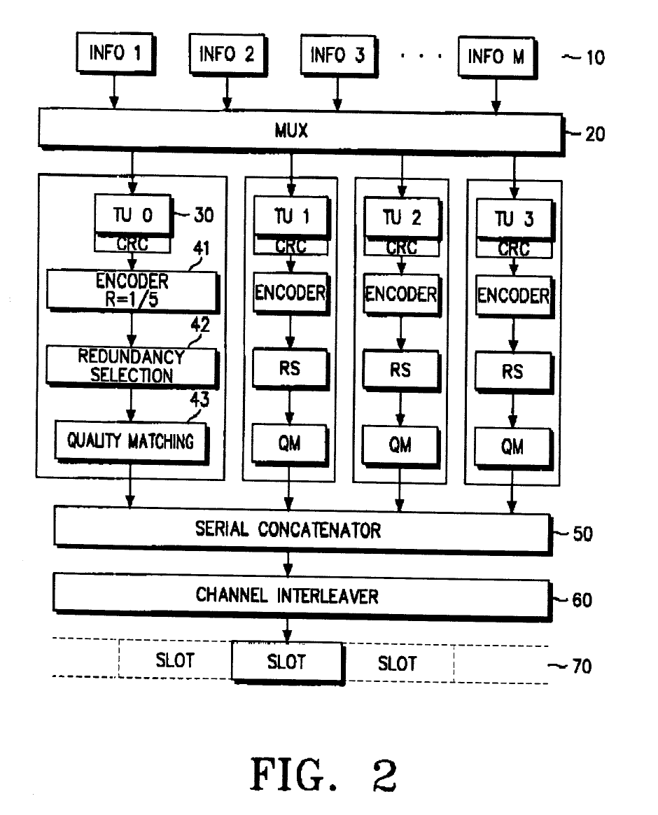

The system may include a plurality of the quality control channels 30, channels for transmitting the data provided from the RLP layer 10 through the MUX layer 20. The respective quality control channels 30 may have different guaranteed QoS levels according to function blocks provided in the physical layer 40. The TUs transmitted over the quality control channels 30 has different lengths for the forward link and the reverse link. The physical layer 40 includes a multiple quality controller (MQC) for providing the different QoS levels through the established quality control channels 30. A detailed description of the multiple quality controller will be made later with reference to FIG. 2. The data output from the multiple quality controller is provided to the serial concatenation part 50. The serial concatenation part 50 serially concatenates the TUs having the different QoS levels, received over the quality control channels 30. Further, the serial concatenation part 50 matches the length of the TUs with the size (length) of the channel interleaver 60. That is, the serial concatenation part 50 constructs a physical layer packet having the same size as that of the channel interleaver 60. The channel interleaver 60 provides an interleaving function in order to transmit the serially concatenated TUs over the physical channel. Further, the channel interleaver 60 provides a symbol puncturing function in addition to the basic function provided in the general mobile communication system. The channel interleaver 60 constructs the physical layer frame 70 through its channel interleaving operation.

FIG. 2 illustrates a detailed structure of the multiple quality controller (MQC) shown in FIG. 1. Reference numeral 10 represents data information blocks Info#1-lnfo#M which correspond to the RLP layer 10 of FIG. 1. That is, the data information blocks Info#0-Info#M are data streams separated according to their classes requiring the different QoS levels in a certain application service. As stated above, the data streams Info#0-Info#M can be either provided with the independent RLP instances, or controlled by a single RLP instance. The MUX layer 20 of FIG. 2 is also identical to the MUX layer 20 of FIG. 1. The data streams output from the MUX layer 20 are provided to the multiple quality controller (MQC) in a TU unit, and the multiple quality controller then adds a CRC (Cyclic Redundancy Check) code to the received TUs TU#0-TU#3. A length of the CRC can be determined depending on the length or characteristic of the generated TUs. In particular, when no data is generated from the MUX layer 20, the CRC may be transmitted as a TU. The CRC added to the respective TUs can also be used as a retransmission unit according to an ARQ (Automatic Repeat Request) technique, a transmission technique supported in a lower layer.

Turbo encoders receive TUs transmitted over the different quality control channels. Herein, the turbo encoders will be described with reference to a turbo encoder 41. The turbo encoder 41 encodes the received TU. Here, either different coding rates or the same coding rate can be applied to the TUs transmitted over the physical layer sub-channels. In addition, in an HARQ (Hybrid Automatic Repeat Request) transmission technique, the coding rate during data retransmission due to occurrence of an error in the initially transmitted data may be different from the coding rate used during the initial transmission. A redundancy selection (RS) part 42 adds a redundancy code to the encoded data. The redundancy selection can be usefully used when HARQ Type II/III is used as a link transmission technique. During retransmission due to the failure of the initial transmission, the redundancy selection part 42 transmits a redundancy matrix, i.e., a complementary code, being different from that used during the initial transmission, to thereby increase combining performance of a receiver. A QoS matching (QM) part 43 actually provides the different QoS levels to the TUs. The QoS matching part 43 properly controls a QM value by puncturing and repetition. The physical channel serial concatenation part 50 provides the TUs to the channel interleaver 60. The TUs assembled by the serial concatenation part 50 are mapped to a transmission slot of the physical channel after being channel interleaved by the channel interleaver 60, and then transmitted to the receiver. The number of TUs mapped to the slots of the physical channel by the channel interleaver 60 can be differently determined according to a data rate of the physical channel.

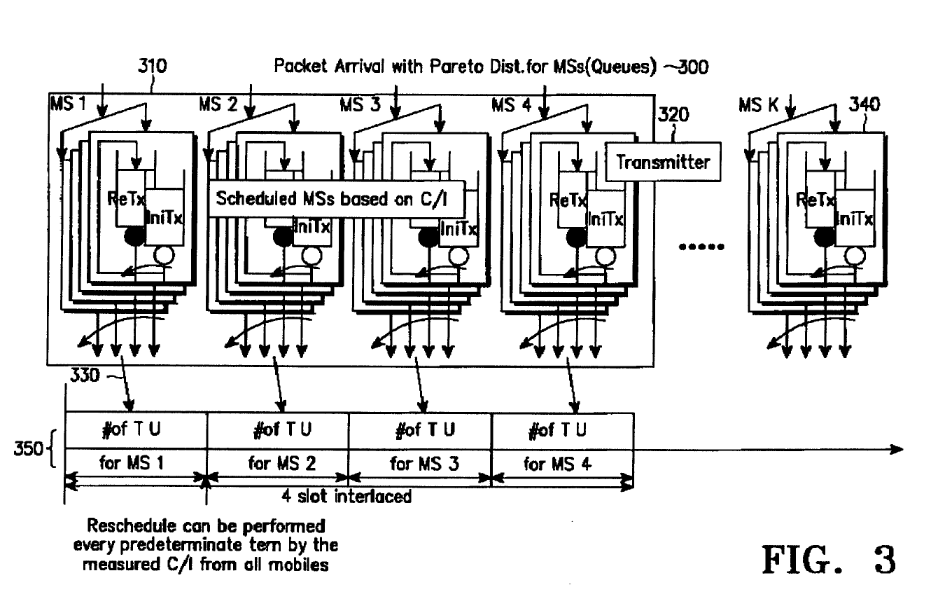

FIG. 3 illustrates a system model for explaining a method for scheduling respective service data of FIGS. 1 and 2 based on a carrier-to-interference ratio (C/I) according to an embodiment of the present invention. Specifically, FIG. 3 illustrates a model base station (BS), and, if the number of mobile stations existing in its cell is assumed to be ‘K’, the base station includes K transmitters for transmitting packet data to their associated mobile stations. The transmitters are mapped with the associated mobile stations on a 1:1 basis. Thus, the base station shown in FIG. 3 has K mobile stations (or transmitters).

Reference numeral 300 represents arrival of the packet data at the base station. That is, the reference numeral 300 shows that the data to be transmitted to the mobile stations is received at the base station, and then constructed into transmission data through the processes of FIGS. 1 and 2. The base station then transmits the arrived data to the mobile stations. The transmission data is provided to the transmitters associated with the mobile stations. A generation probability of the packet data can be calculated using ‘Pareto with Cutoff Model’. Alternatively, the probability can also be calculated using Poisson Distribution or other probability distributions. The above-stated distribution methods use a model capable of most accurately expressing a traffic model of packet data including WWW traffic. Reference numeral 310 represents a transmitter that transmits data at a certain instant based on a DRQ (Data Rate reQuest) value reported from the mobile stations. If the number of mobile stations in the cell is K, scheduling is sequentially performed from a transmitter having the highest C/I to a transmitter having the lowest C/I at a given time ‘t’. The DRQ value can be determined as shown in Table 1.

TABLE 1

| Data Rate (DRQ) [Kbps] | Number of Slots | Number of TUs |
|---|---|---|
| 19.2 | 32 | 1 |
| 38.4 | 16 | 1 |
| 76.8 | 8 | 1 |
| 153.6 | 4 | 1 |
| 307.2 | 2 | 1 |
| 614.4 | 1 | 1 |
| 307.2 | 4 | 2 |
| 614.4 | 2 | 2 |
| 1228.8 | 1 | 2 |
| 921.6 | 2 | 3 |
| 1843.2 | 1 | 3 |
| 1228.8 | 2 | 3 |
| 2457.6 | 1 | 4 |

Table 1 shows the number of slots and TUs, required for the DRQ values, according to an embodiment of the present invention. As shown in Table 1, the mobile station reports its DRQ value to the base station. That is, the mobile station measures a level of a pilot from the base station, and then informs the base station of its available data rate. The base station then transmits the packet data at the data rate reported by the mobile station. Therefore, reporting DRQ to the base station by the mobile station is equivalent to reporting C/I to the base station by the mobile station.

When K mobile stations exist in a cell of the base station, the base station includes K transmitters 320 in a block 310. Each of the transmitters 320 has queues, since the base station performs buffering in order to transmit the received packet data to the mobile stations. For examples, the base station can operate a maximum of 4 MQC channels as shown in FIG. 2, it includes a maximum of 4 queues. In addition, the queues allocated to the 4 MQC channels each have one retransmission queue in order to retransmit the packet, i.e., transmission-failed TUs during transmission. Therefore, each transmitter includes a maximum of 4 initial transmission IniTx queues and 4 retransmission ReTx queues. In FIG. 3, IniTx represents a queue for storing the TU for initial transmission, and ReTx represents a queue for storing the TU for retransmission. That is, the transmitter is comprised of the IniTx queues and the ReTx queues, and the base station includes a maximum of 4 queue sets comprised of the IniTx queues and the ReTx queues, as the MQC structure provides a maximum of 4 MQC channels. Further, transmission of the queue sets included in the transmitters is determined according to their priority.

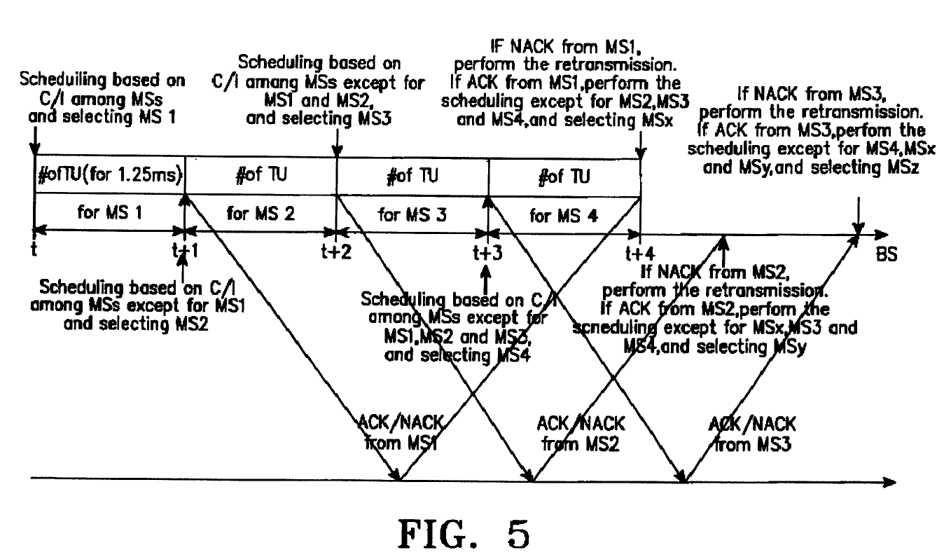

Arrows 330 represent a process of mapping the TUs to the physical channel to transmit the TUs by the base station. The physical channel may be a dedicated channel for transmitting forward packet data or a general traffic channel. In addition, reference numeral 340 represents a transmitter, which is not subject to scheduling due to its low C/I value. Such a transmitter 340 not subjected to scheduling is a transmitter with empty queues, i.e., a transmitter with no data to transmit. After the scheduling, the transmission data of the transmitters is mapped to the mobile stations on a time division basis. Reference numeral 350 represents a structure of the physical channel to which the TUs are mapped. The base station can reschedule the mapping depending on the C/I at stated periods or in a given time unit. Here, the given time can be 1.25 ms. The number of TUs transmitted at one slot is determined based on the DRQ value transmitted from the base station. The mapping process 350 will be described in detail with reference to FIG. 5.

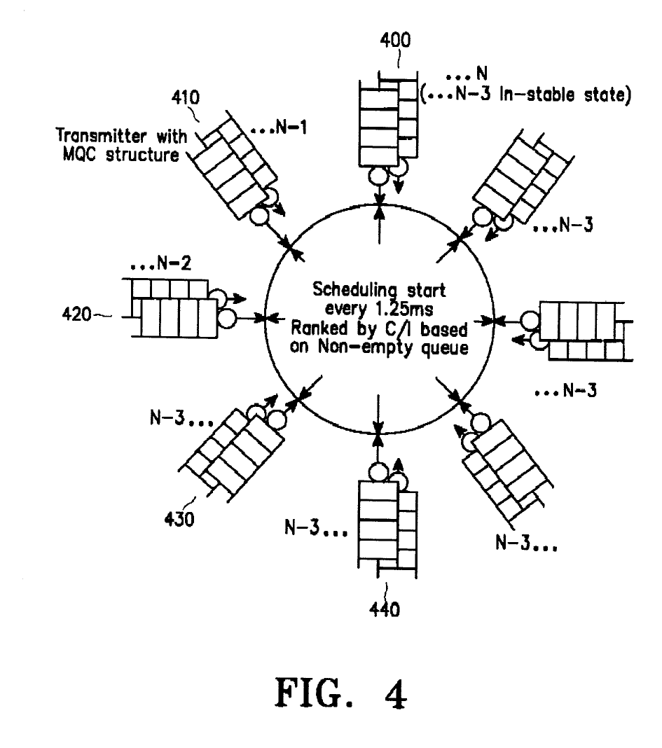

FIG. 4 illustrates a C/I-based scheduling process by the transmitters. If it is assumed that N mobile stations exist in a cell of the base station, the base station has N transmitters. However, the base station performs scheduling on only the transmitters with non-empty queues, among the N transmitters.

Reference numeral 400 represents an initial scheduling process. If the N transmitters are not in an empty-queue state, the base station performs transmission scheduling by comparing the C/I values of the N transmitters. In the process 400, the N transmitters are subject to scheduling as illustrated in FIG. 4. After a lapse of a predetermined time during data transmission after the scheduling, the base station performs rescheduling in process 410. Therefore, if the transmitter having transmitted the data after being scheduled in the process 400, fails to receive ACK or NACK information, the base station performs scheduling by comparing C/I values of (N−1) transmitters, excluding the transmitter scheduled in the process 400. Reference numeral 420 represents a rescheduling process after the process 410. If the transmitter having transmitted the data after being scheduled in the processes 400 and 410 fails to receive feedback information such as the ACK or the NACK, the transmitter scheduled in the processes 400 and 410 is excluded from the rescheduling process 420. That is, the number of transmitters, which are to transmit the data, is N−2.

Reference numeral 430 represents a 4^{th} scheduling process. This process is performed in the same way as the processes 400, 410 and 420. Reference numeral 440 represents a 5^{th} scheduling process. If a 4-slot interlaced structure according to the present invention is used, a response to the packet data transmitted in the process 400 is received before the process 440. Therefore, if the response received in the process 400 is an ACK signal, the rescheduling is performed including the transmitter scheduled in the process 400, in the process 440. However, if the response received in the process 400 is a NACK signal, the packet data having been transmitted in the process 400 is retransmitted in the process 440.

FIG. 5 illustrates a timing diagram for explaining a transmission method based on C/I scheduling during retransmission in a TU unit according to an embodiment of the present invention.

Reference numeral 500 represents an initial scheduling process by the base station. If the queues of the transmitter are not empty during the scheduling, the base station selects a transmitter of the mobile station having transmitted the highest DRQ. The transmitter should be selected within a predetermined time, and the predetermined time is, for example, 1.25 ms. In addition, the base station transmits the data to a specific mobile station, for example, a first mobile station MS1, for a slot time of the predetermined time unit. Here, the number of TUs included in one slot is determined as shown in Table 1. Of course, the number of the TUs is determined depending on the data rate, and the base station transmits the TUs at a data rate required by the mobile station. If the mobile station requests a data rate of 2.5 Mbps, the base station can transmit a maximum of 4 TUs for one-slot time as shown in Table 1. Otherwise, if the mobile station requests a data rate of 19.2 Kbps, the base station requires a 32-slot time in order to transmit one TU. At a time ‘t’, the base station transmits the TU to the first scheduled mobile station MS1.

Reference numeral 505 represents a 2^{nd} scheduling process performed at a time (t+1). In the process 505, scheduling is performed on the transmitters other than the transmitter associated with the MS1. Reference numeral 510 represents completion of transmission by the transmitter scheduled in the process 500. A response (ACK or NACK) to the process 510 is transmitted from the mobile station to the base station at a (t+4)-slot time. Reference numeral 515 represents a 3^{rd} scheduling process. Since the base station has failed to receive a response after transmitting data to MS1 and MS2, the transmitters associated with the MS1 and the MS2 are excluded from the scheduling at a time (t+2). Reference numeral 520 represents completion of data transmission to the MS2 as in the process 510. Reference numeral 545 represents a response process to the process 520. Reference numeral 525 represents a scheduling point for 4^{th} transmission, and the scheduling is performed while excluding the MS1, MS2 and MS3 as stated above.

Reference numeral 530 represents a point where a response process 540 to the process 510 is performed in the 4-slot interlaced structure according to the present invention. If a response in the process 540 is ACK, the rescheduling is performed including the MS1, while excluding the MS2, MS3 and MS4. However, if the response is NACK, retransmission to the MS1 is performed without rescheduling. Reference numeral 535 represents a process for transmitting the TU to the MS3, and the MS3 transmits a response to the TU to the base station through a process 555. Reference numeral 540 represents a response to the process 510, and the base station determines rescheduling or retransmission according to the type (ACK/NACK) of the response in the process 540. Reference numeral 545 represents the case where the base station receives a response signal from the MS2. In the process 545, the MS2 transmits a response signal for determining the rescheduling or the retransmission, to the base station. Reference numeral 550 represents a rescheduling process. The base station performs the same operation as in the process 530 based on a response for the process 545. The processes 555 and 560 are performed as described above.

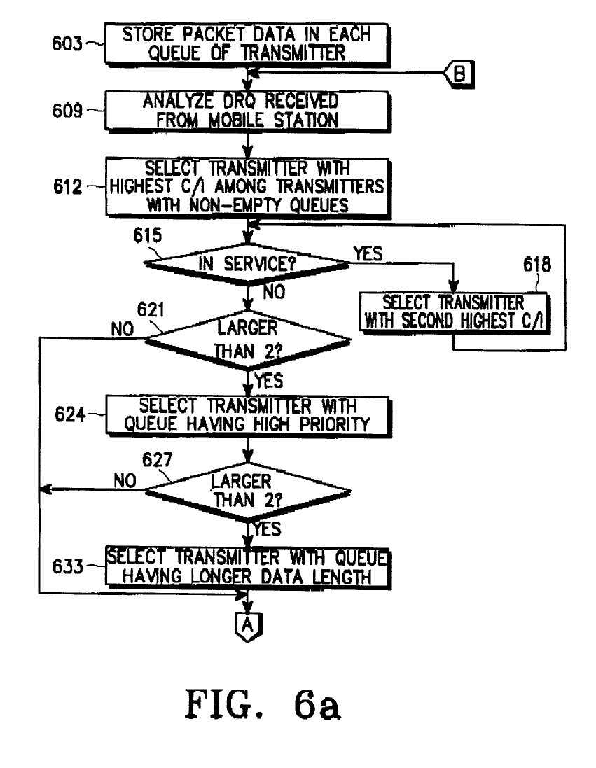

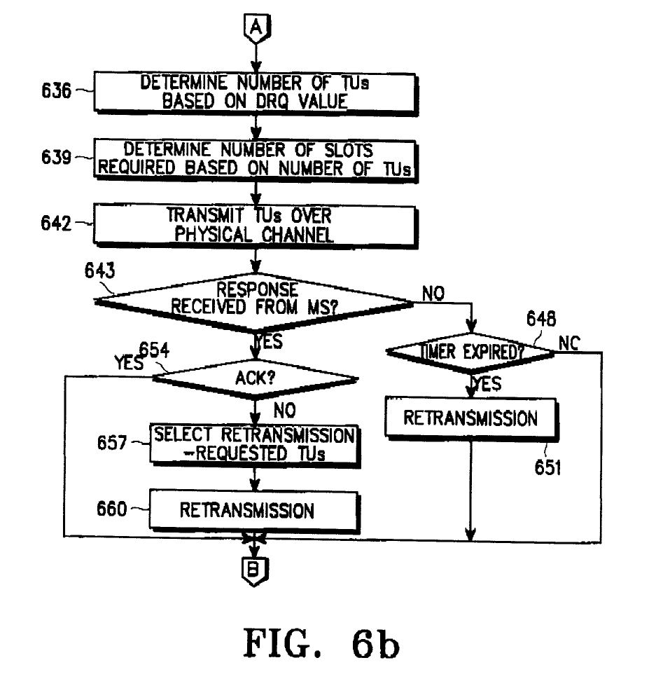

FIGS. 6A and 6B illustrate a C/I-based scheduling procedure by the base station. The scheduling procedure according to an embodiment of the present invention will now be described with reference to FIGS. 1 to 6B.

Upon receipt of packet data to be transmitted to the mobile station, the base station stores the received packet data in a queue associated with the mobile station in step 603. In the system according to the present invention, the packet data is separated in a specific size. In addition, since the transmitter has 4 queues according to the priority, the received packet data is stored in one of the 4 queues according to the priority based on its service class. In step 609, the base station analyzes a DRQ value transmitted from the mobile station. To determine the DRQ value, the mobile station measures a level of a pilot received from the base station, converts the measured pilot level to a DRQ value shown in Table 1, and then transmits the DRQ value to the base station, thereby to inform the base station of its available data rate. The mobile station measures a ratio C/I of a carrier level ‘C’ of a pilot from a current serving base station to an interference level ‘I’ of a plurality of pilot received from other base station, and determines its available data rate.

Upon receiving the C/I value as a DRQ value in the step 609, the base station selects a mobile station having transmitted the highest C/I value, i.e., a mobile station requiring the highest data rate. The process of the step 609 is performed within a predetermined time, e.g., 1.25 ms. In step 612, the base station combines the transmitters having a queue with buffered packet data, i.e., a non-empty queue in which transmission data is stored, in the order of highest C/I to the lowest C/I. The base station extracts a transmitter having a non-empty queue and a highest C/I. Thereafter, in step 615, the base station determines whether the extracted transmitter is in service. The “transmitter in service” refers to a transmitter, which has failed to receive ACK or NACK from the mobile station after transmitting the data. If the currently selected transmitter is a transmitter in service, the base station proceeds to step 618.

In step 618, the base station selects a transmitter with a non-empty queue that has transmitted the second-highest DRQ value, to exclude the current serving transmitter from the scheduling. After selecting the transmitter in the step 618, the base station determines again in the step 615 whether the selected transmitter is in service. If the selected transmitter is not in service, the base station proceeds to step 621. The process of the step 618 is repeatedly performed until a transmitter not in service is detected, and this process is performed for the same time as required in the process of the steps 609 and 612. In the step 621, the base station determines whether the number of the transmitters having the maximum C/I value among the transmitters with the non-empty queues is larger than 2. If the number of the transmitters having the maximum C/I value is 1 in the step 621, the base station proceeds to step 636. Otherwise, the base station proceeds to step 624 to select another transmitter.

In step 624, the base station analyzes a status of the initial transmission queue IniTx to select one of the transmitters extracted in the step 621. As described above, each transmitter is provided with 4 initial transmission queues IniTx, and each queue is allocated its priority. In the step 624, the base station selects a transmitter with a non-empty queue having the top priority, by analyzing the status of the queue having the top priority. In step 627, the base station determines whether the number of the transmitters selected in the step 624 is larger than 2. If the number of the transmitters with the non-empty queue having the top priority is 1, the base station proceeds to the step 636. The fact that there remains only one transmitter is equivalent to that transmitter being selected. However, if the number of the transmitters having the maximum C/I value is larger than 2 and their queues with the top priority are not empty, the base station proceeds to step 633. In the step 633, the base station selects one transmitter among the more-than-two transmitters with the non-empty queues having the same maximum C/I value and the same priority. If the queues having the same C/I value and the same priority are not empty, the base station selects a transmitter having a longer queue by determining the lengths of the queues having the same priority.

In the step 636, the base station transmits a packet data converted to TU by the selected transmitter. As shown in Table 1, the base station determines the number of TUs that can be transmitted for one-slot time based on the DRQ value received from the mobile station. As the data rate requested by the mobile station is higher, the number of TUs to be transmitted becomes larger. The base station can transmit a minimum of 1 TU and a maximum of 4 TUs for one-slot time. In step 639, the base station determines the number of slots required for transmitting the TUs, the number of which is determined in the step 636. As shown in Table 1, the base station determines the number of the required slots based on the DRQ value received from the mobile station. That is, the base station requires a minimum of 1 slot and a maximum of 32 slots in order to transmit the TUs determined to be transmitted based on the data rate requested by the mobile station. In step 642, the base station maps the TUs determined to be transmitted, to the determined slots. Here, for a physical channel for transmitting the TUs, the base station can use either a channel exclusively allocated for the packet or an existing traffic channel. When the selected mobile station MSx, a mobile station selected in the process of the steps 612 to 633, uses the common packet channel, the base station transmits the packet data to one mobile station at a certain instant.

The base station determines in step 643 whether a response to the packet data transmitted in the step 642 is received from the mobile station. Since the system according to the present invention uses the 4-slot interlaced structure, the base station should receive a response to a slot transmitted at a given time ‘t’, before a (t+4)^{th} slot. The time point where the response signal is received is dependent on the structure applied to the system. If the system has a 5-slot interlaced structure, the base station should receive a response signal from the mobile station before a (t+5)^{th} slot. If the base station has received a response signal of ACK or NACK from the mobile station in the step 643, the base station proceeds to step 654. Otherwise, the base station proceeds to step 648. In the step 648, the base station determines whether a timer activated after transmitting the packet data to the mobile station has expired. The base station activates the timer to prepare for the case that it fails to receive a response signal due to a loss of the response signal from the mobile station. The timer is set to a maximum response waiting time, and in the embodiment of the present invention, the timer is so set as to expire before the 4^{th} slot after transmitting the current slot. If no response signal is received from the mobile station until the timer expires in the step 648, the base station proceeds to step 651, considering the response signal as NACK. However, if the timer has not expired yet, the base station proceeds to step 609.

After expiration of the timer in the step 648, the base station retransmits the packet data in step 651, considering the response signal as NACK. In the embodiment of the present invention, since the timer expires before the start of the (t+4)^{th} slot, the base station retransmits the packet data to the MSx at the (t+4)^{th} slot. After the retransmission in the step 651, the base station proceeds to the step 609.

The base station determines in the step 654 whether the response signal received in the step 643 is ACK or NACK. If the response signal received from the mobile station MSx is ACK, it means that transmission of the packet to be currently transmitted, i.e., the TU is completed. Thus, the transmitter is changed to a no-service state, and then the process of the step 609 is performed. If the base station performs the step 609 after the response signal is determined as ACK in the step 654, the transmitter is in the no-service state unlike in the steps 648 and 651, so that the transmitter may be subject to scheduling. In other words, the base station retransmits the packet in the steps 648 and 651 as it receives NACK from the mobile station, so that no new packet is transmitted. Therefore, the transmitter is in the service state. However, if the base station receives ACK, it means that the packet transmission is completed. In this case, the transmitter can transmit a new packet, so that the transmitter is subject to scheduling.

Upon receiving NACK in the step 654, the base station proceeds to step 657. As shown in Table 1, the base station can transmit a maximum of 4 TUs for one-slot time at the maximum data rate. Therefore, upon receipt of NACK, the base station determines the TU where NACK (or error) occurs, and retransmits only the previously error-occurred (failed) TU. For example, if the NACK signal is received after transmitting the 4 TUs, the NACK signal is constructed to include information on the previously failed TU out of the 4 transmitted TUs. Therefore, if the base station has transmitted TU#1, TU#2, TU#3 and TU#4, then the mobile station may request retransmission of only TU#2 and TU#4, or retransmission of only TU#1, TU#2 and TU#3, or retransmission of only TU#4. That is, the mobile station requests retransmission of the reception-failed TUs. Therefore, such an operation is applied to the case where two or more TUs are transmitted. In addition, the mobile station transmits the response signal to the base station, using a structure capable of transmitting response signals for a maximum of 4 TUs. That is, this is different from the retransmission of the step 651.

When the base station performs retransmission after the expiration of the timer in the step 648, it is necessary to distinguish the case where an error has occurs in a specific TU. This is because when two or more TUs are transmitted, it is considered that errors occurred in all of the TUs. In step 660, the base station retransmits the TU selected in the step 657. After retransmission of the TU, the base station proceeds to the step 609. When the base station performs the step 609 after the steps 648, 651 and 660, the current transmitter is in the service state. Whether the transmitter is in the service state is determined in the step 615.

As described above, the present invention can provide high-rate (high-speed) data transmission and higher throughput during the data transmission by scheduling in a protocol structure capable of providing a data service and a multimedia service.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for selecting one of a plurality of mobile stations by a base station having a plurality of transmitters, each of the transmitters having a retransmission buffer for storing retransmission data and an initial transmission buffer for storing initial data, the plurality of transmitters being capable of providing a data service to associated mobile stations, the base station providing a data service to the selected one of the mobile stations based on C/I (Carrier-to-Interference ratio) information from the mobile stations, comprising the steps of:
analyzing the retransmission buffers and the initial transmission buffers in the plurality of transmitters associated with the mobile stations having transmitted at least two C/I information, when at least two C/I information are equal to each other, and selecting a mobile station associated with a retransmission buffer in which retransmission data is stored, when the retransmission data is stored in said retransmission buffer among the retransmission buffers of the plurality of transmitters;
selecting a mobile station associated with a transmitter transmitting data having a high priority among the transmitters associated with at least two retransmission buffers, when the retransmission data is stored in at least the two retransmission buffers among the retransmission buffers of the plurality of transmitters; and
selecting a mobile station associated with a retransmission buffer having a longest data length among the retransmission buffers in the two transmitters, when there exist at least two transmitters transmitting data having a high priority.

2. The method as claimed in claim 1, further comprising the step of retransmitting the transmitted data upon failure to receive a response signal from the mobile station within a predetermined time after transmitting the data stored in the transmitter associated with the selected mobile station.

3. The method as claimed in claim 1, further comprising the step of retransmitting only previously failed data when a response signal received from the mobile station within a predetermined time after transmitting the data stored in the transmitter associated with the selected mobile station indicates that an error has occurred in part of the transmitted data.

4. The method as claimed in claim 1, wherein the base station selects one of the transmitters excluding a transmitter currently transmitting data to the current mobile station.

5. The method as claimed in claim 1, wherein the base station selects one of the transmitters excluding transmitters whose response waiting time has not expired after transmitting data.

6. A method for selecting one of plurality of mobile stations by a base station having a plurality of transmitters, the number of the transmitters being equal to the number of the mobile stations for transmitting the data, each of the transmitters having a retransmission buffer for storing retransmission data and an initial transmission buffer for storing initial data, the plurality of transmitters being capable of providing a data service, the base station providing a data service to the selected one of the mobile stations based on C/I (Carrier-to-Interference ratio) information from the mobile stations, comprising the steps of:
selecting by the base station a transmitter having a highest C/I received from the mobile stations among the transmitters other than transmitters having no data and transmitters whose response waiting time has not expired after transmitting data, and transmitting data to the selected mobile station.

7. The method as claimed in claim 6, wherein the base station selects a transmitter with a queue having a high priority among the transmitters, when the number of the transmitters selected based on the C/I received from the mobile station is larger than 2.

8. The method as claimed in claim 7, wherein the base station selects a transmitter having a longer data length among the transmitters, when the number of transmitters selected according to the priority is larger than 2.

9. The method as claimed in claim 6, further comprising the step of retransmitting the transmitted data upon failure to receive a response signal from the mobile station within a predetermined time after transmitting the data stored in the transmitter associated with the selected mobile station.

10. The method as claimed in claim 6, further comprising the step of retransmitting only previously failed data when a response signal received from the mobile station within a predetermined time after transmitting the data stored in the transmitter associated with the selected mobile station indicates that an error has occurred in part of the transmitted data.
